(19) United States
(12) Patent Application Publication
(10) Pub. No.: US 2016/0364126 A1
(43) Pub. Date: Dec. 15, 2016

(54) DYNAMIC ADAPTIVE USER INTERFACE CONTROL

(71) Applicant: SAP SE, Walldorf (DE)

(72) Inventor: Tao Li, Berlin (DE)

(21) Appl. No.: 14/737,039

(22) Filed: Jun. 11, 2015

(51) Int. Cl. G06F 3/0484; G06F 3/0483; G06F 3/0482

(52) U.S. Cl. CPC G06F 3/04847; G06F 3/04842; G06F 3/0482; G06F 3/0483; G06F 2203/04803

(57) ABSTRACT

A method for an adaptive user interface control on a display of a computing device, comprising displaying primary information in a graphical user interface on the display, the primary information being provided by a processor of the computing device, the processor receiving the primary information for display from a remote computer electronically connected to the processor, providing one or more secondary information for selection viewable with the primary information on the display, the selection of the secondary information based on user input such that the selected secondary information is provided by the remote computer to the computing device, and adaptively displaying in the graphical user interface a displayable toggle button including the selected secondary information displayed when the toggle button is expanded and hidden when the toggle button is contracted, wherein the secondary information is data related to the primary information and viewable on the display of the computing device simultaneously in the graphical user interface.

### TECHNICAL FIELD

The present disclosure relates to a system and method for an adaptive user interface control.

### BACKGROUND

When viewing various information in a graphical user interface, various types of related data are often displayed separated by one or more tabs. A user viewing information separated by multiple display screens must then continuously switch back and forth to view desired information. When multiple types of information are presented on the same display for viewing, data can appear condensed and confusing, and therefore not helpful for a user to understand connections between the information. Information can be especially difficult to view on mobile computing devices, such as mobile phones and tablets, having smaller screen sizes.

### SUMMARY

Accordingly, a need exists for providing a system and method for dynamically and adaptively displaying information desired for viewing.

An embodiment of the present disclosure relates to a method for an adaptive user interface control on a display of a computing device. The method includes displaying primary information in a graphical user interface on the display, the primary information being provided by a processor of the computing device, the processor receiving the primary information for display from a remote computer electronically connected to the processor; providing one or more secondary information for selection viewable with the primary information on the display, the selection of the secondary information based on user input such that the selected secondary information is provided by the remote computer to the computing device; and adaptively displaying in the graphical user interface a displayable toggle button including the selected secondary information displayed when the toggle button is expanded and hidden when the toggle button is contracted; wherein the secondary information is data related to the primary information and viewable on the display of the computing device simultaneously in the graphical user interface.

According to an embodiment of the present disclosure a method further includes linking additional information to the secondary information, wherein the additional information is displayable by selection of at least one of the primary information and the secondary information. The computing device is a mobile computing device. The primary information is displayed in chart form. The secondary information is displayed in table form. The additional information is displayed in list form below the selected secondary information. The secondary information is displayed in table form and aligned with the respective primary information displayed in chart form.

An embodiment of the present disclosure relates to a system for an adaptive user interface control on a display of a computing device. The system includes at least one remote computer; a computing device including a processor, memory, and display; a user interface on the display of the computing device for controlling information on the display; wherein, the system is configured to: display primary information in a graphical user interface on the display, the primary information being provided by a processor of the computing device, the processor receiving the primary information for display from a remote computer electronically connected to the processor; provide one or more secondary information for selection viewable with the primary information on the display, the selection of the secondary information based on user input such that the selected secondary information is provided by the remote computer to the computing device; and adaptively display in the graphical user interface a displayable toggle button including the selected secondary information displayed when the toggle button is expanded and hidden when the toggle button is contracted; wherein the secondary information is data related to the primary information and viewable on the display of the computing device simultaneously in the graphical user interface.

According to an embodiment of the present disclosure the system is further configured to: link additional information to the secondary information, wherein the additional information is displayable when the displayed secondary information in the toggle button is selected. The computing device is a mobile computing device. The primary information is displayed in chart form. The secondary information is displayed in table form. The additional information is displayed in list form below the selected secondary information. The secondary information is displayed in table form and aligned with the respective primary information displayed in chart form.

An embodiment of the present disclosure relates to a method for an adaptive user interface control on a display of a computing device, comprising: displaying primary information in a graphical user interface on the display; providing one or more secondary information for selection viewable with the primary information on the display, the selection of the secondary information based on user input; and adaptively displaying in the graphical user interface a displayable toggle button including the selected secondary information displayed when the toggle button is expanded and hidden when the toggle button is contracted; wherein the secondary information is data related to the primary information and viewable on the display of the computing device simultaneously in the graphical user interface.

### BRIEF DESCRIPTION OF THE DRAWINGS

FIGS. 1A to 1C illustrate a user interface according to an embodiment of the present disclosure.

FIGS. 1D and 1E illustrate a user interface according to an embodiment of the present disclosure.

FIGS. 2A to 2E illustrate a user interface according to an embodiment of the present disclosure.

FIG. 3 illustrates a system according to an embodiment of the present disclosure.

### DETAILED DESCRIPTION

Example embodiments of the present disclosure relate to a system and method for an adaptive graphical user interface control.

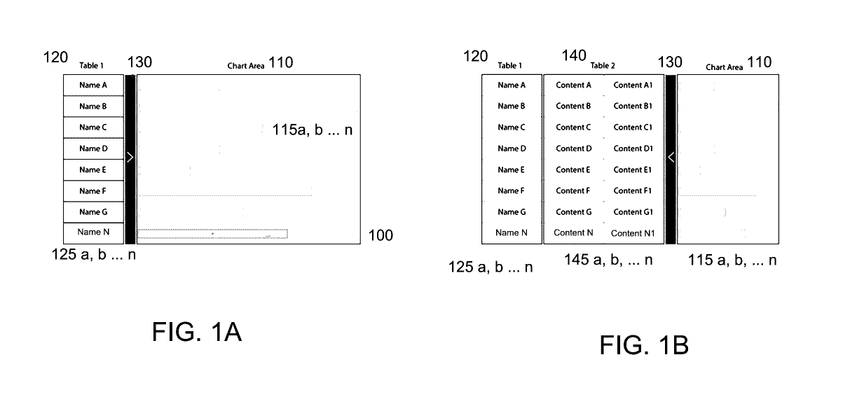

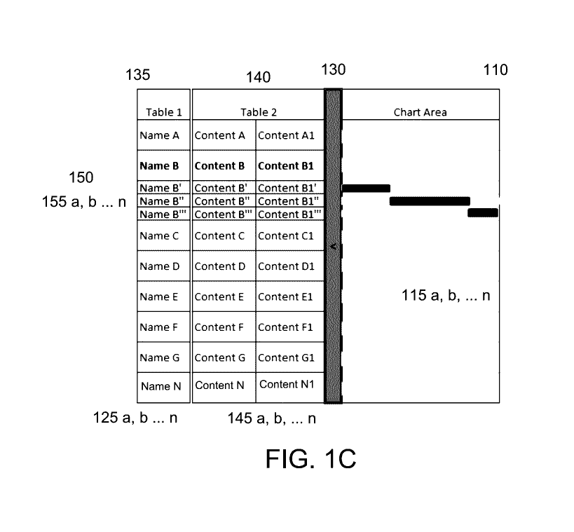

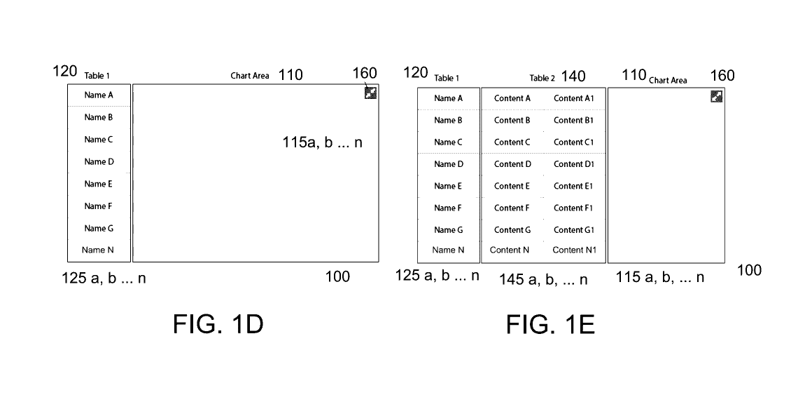

FIGS. 1A to 1C illustrate an embodiment of the graphical user interface (GUI) according to present disclosure. FIG. 1A shows display 100 including primary information 110, 120. In embodiments, information 120 can include a list of data information 125a, b, . . . n, of interest to a user. Information 120 is related to the information 110, for example, a list of company names, and financial information for each company. Information 120 can be displayed in table form, although it can be displayed in any manner indicating its relation to information 110. Information 110 can be displayed in chart form, for example, a bar chart, to display data 115a, b, . . . n. Other types of known charts can be used, including but not limited to histograms, pie charts, and line charts. Toggle button 130 can be positioned between information 110 and information 120, as a divider.

FIG. 1B shows display 100 when the toggle button 130 is expanded upon user selection. Toggle button 130 displays secondary information 140 including data 145a, b, . . . n. The information 140 that is displayed is adaptive to user selection. A user selects one or more secondary information 140 for display. For example, FIG. 1B shows data 145a, b, . . . n can include Content A, B, . . . N, Content A1, B1, . . . N1, etc. When toggle button 130 is expanded, the display 100 can show all of the one or more selected secondary information 140. Secondary information can be related to the primary information, for example, a list of company names, and financial information as the primary information, and ratings information for the secondary information. The secondary information 140 can be hidden when the toggle button is selected to be hidden, for example, as shown in FIG. 1A. Toggle button 130 can indicate a hidden and/or expanded mode by a graphical feature. In embodiments, the graphical feature can be an arrow. FIG. 1A shows a right-pointing arrow, indicating the toggle button 130 is in hidden mode. FIG. 1B shows a left-pointing arrow, indicating the toggle button 130 is in expanded mode. Toggle button 130 can be displayed as a bar positioned between information 110 and information 120, and can be displayed as other known shapes. Toggle button 130 can be positioned on the display 100 in other areas, for example, positioned for easy identification and access to view information.

FIG. 1C shows an embodiment including viewing additional information in the display 100. Data 145a of primary information 110, 120 can be selected by the user. When data 145a is selected, additional information 150 is displayed including data 155a, b, . . . n. FIG. 1C shows for example, when data related to Name B is selected, subcontent B′, B″, . . . Bⁿ is displayed. Additional information 150 is related to primary information 110, 120. Additional information 150 can be related to secondary information 140. For example, additional information 150 can be a breakdown of primary information 110, 120 and/or secondary information 140. Data 155a, b, . . . n which is related to secondary information 140 can be displayable by the toggle button 130 in the same manner as secondary information 140 as more fully described above. Thus, subcontent related to primary information 110, 120 can be displayed whether the toggle button 130 is expanded or hidden, while the subcontent related to secondary information 140 can be displayed when the toggle button 130 is in expanded mode and not displayed when the toggle button 130 is in hidden mode. When the toggle button is expanded displaying secondary and/or additional information, the display of the primary information is adjusted to fit all of the selected information on a display screen. For example, adjustments can be made to the scale of the display. Primary information displayed as a bar chart can be adjusted to scale the axis so that all desired information is viewable.

FIGS. 1D and 1E illustrate an embodiment of the graphical user interface (GUI) according to the present disclosure. FIG. 1D shows a similar display as in FIG. 1A, and FIG. 1B shows a similar display as in FIG. 1B. Toggle button 130 is displayed as expansion button 160. Expansion button 160 can be positioned in a corner of the display 100. Expansion button can be positioned anywhere on a screen, for example, positioned for easy identification and access to view information. When the expansion button is expanded displaying secondary and/or additional information, the display of the primary information is adjusted to fit all of the selected information on a display screen. For example, adjustments can be made to the scale of the display. Primary information displayed as a bar chart can be adjusted to scale the axis so that all desired information is viewable.

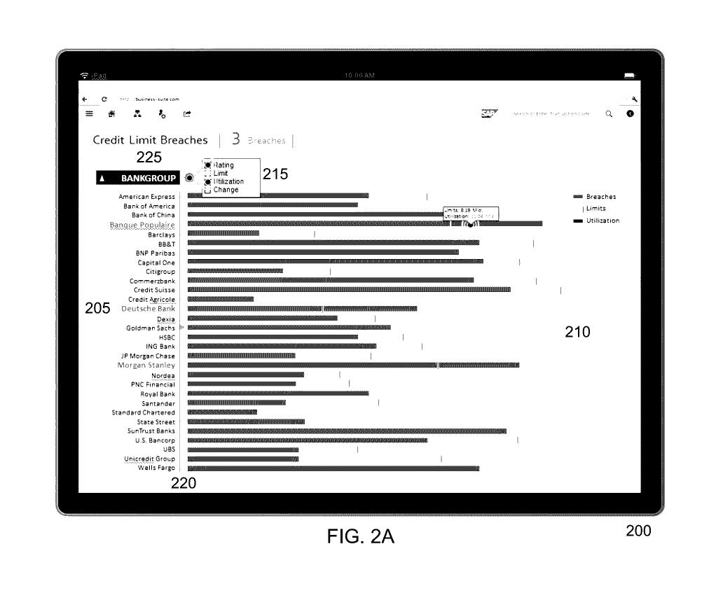

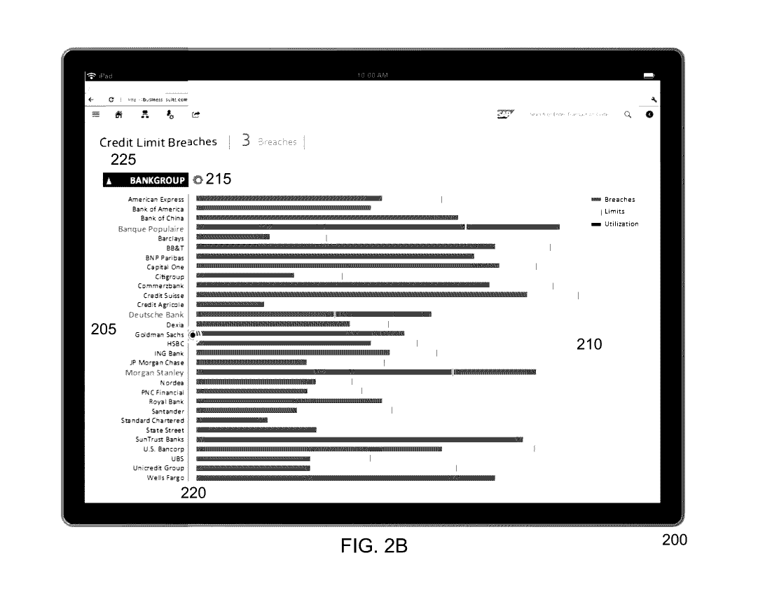

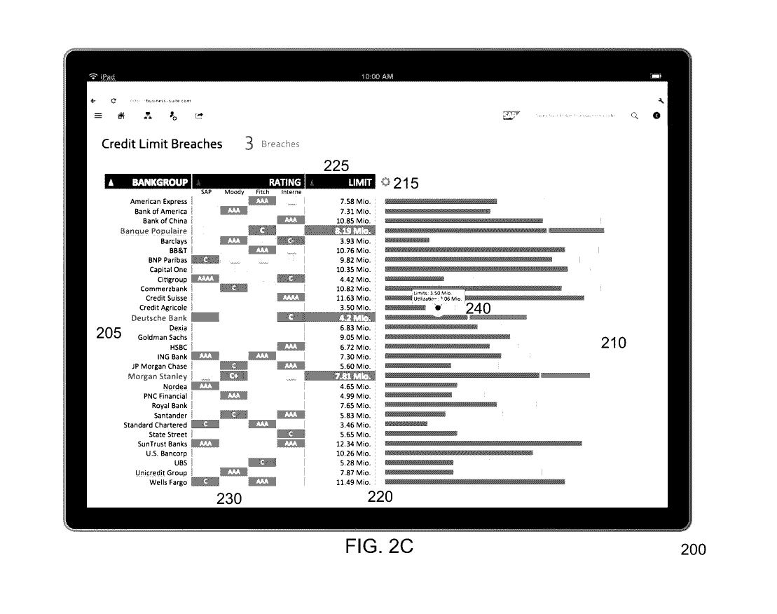

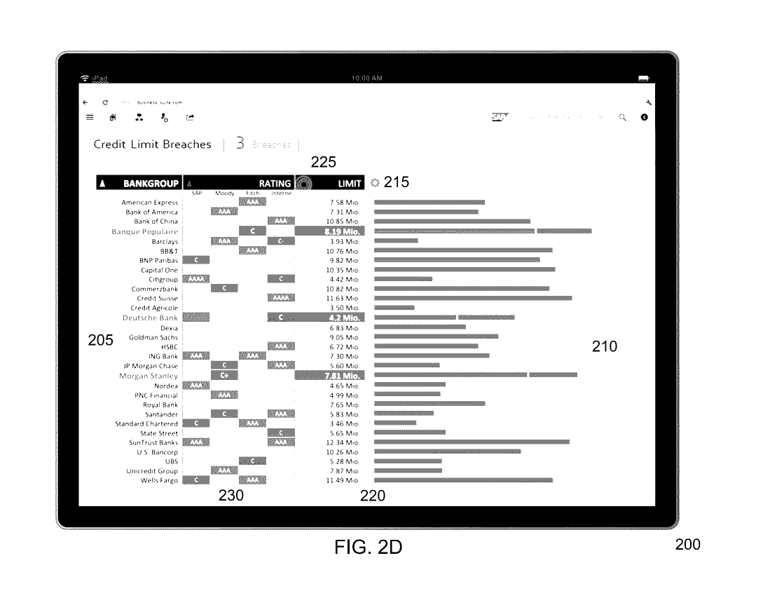

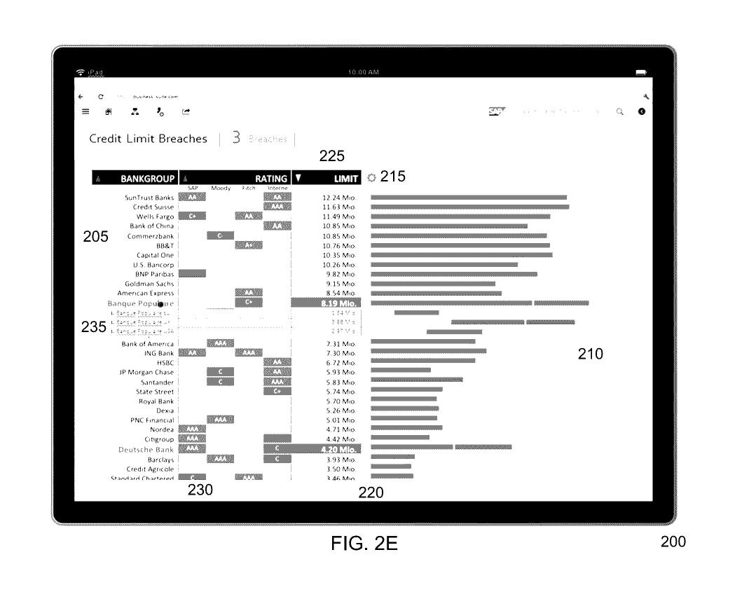

FIGS. 2A to 2E illustrate an embodiment of the graphical user interface (GUI) according to present disclosure. FIG. 2A shows display 200 on a computing device, for example, a mobile computing device. Primary information 205, 210 is shown on display 200, separated by toggle button 220. For example, primary information 205 can include one or more categories of data, and 210 can include charted data related to those categories. Title bar 225 shows the titles of the categories of data. For example, FIG. 2A shows title bar 225 including “Bankgroup,” with the data including names of banks. Title bar 225 can be selected by the user so that the information is reordered by at least one of alphabetical order, numerical order, and/or chronological order.

FIG. 2A includes on the display a filter 215. Filter 215 can include one or more options of secondary information for selection by a user. Filter 215 can be displayed by a graphical object, and when selected by the user, displays a pop-up box including the one or more secondary information for selection. For example, FIG. 2C includes secondary information including “Rating,” “Limit,” and “Utilization.”

FIG. 2B shows display 200 after a user selection of one or more options in filter 215. The toggle button 220 is in hidden mode, so that only primary information 205, 210 is displayed.

FIG. 2C shows display 200 when toggle button 220 is in expanded mode. When the toggle button is in expanded mode, the selected one or more secondary information 230 selected in the filter 215 is displayed. The title bar 225 is also expanded to show the title of categories of secondary information 230. For example, FIG. 2C includes “Rating” and “Limit.” The user interface is adaptive, in that any of the secondary information 230 selected in the filter 215 as described with respect to FIG. 2B can be displayed when the toggle button 220 is in expanded mode. The adaptive feature advantageously allows a user to view information of importance on one display without having to view information on multiple tabs and/or displays. Secondary information 230 displayed when the toggle button 220 is in expanded mode changes depending on the categories selected in the filter 215. That is, the secondary information 230 is displayed dynamically and adaptively based on the selections of filter 215.

In an embodiment, the primary information 210 can be displayed as itemized by the secondary information 230. For example, when primary information 210 is displayed as a bar chart, the bar of the individual data 205 can be broken down to show one or more components of the chart related to the secondary information.

In an embodiment, the primary information can be displayed so that when selected, a pop-up box 240 including secondary information is displayed. For example, if a cursor is brought to hover over primary information displayed as a bar chart, secondary information can be displayed.

FIG. 2D shows display 200 including title bar 225. As described above, title bar 225 can be reordered to at least one of alphabetical order, numerical order, and/or chronological order. For example, primary information 205, 210 is displayed as alphabetical order. A graphical object, such as an arrow is shown on the title bar 225 next to the reordered title, to indicate whether the information is displayed top-to-bottom, or bottom-to-top. For example, FIG. 2D shows that “Limit” secondary information 230 is displayed by the primary information being ordered in chronological order by “Bankgroup.” FIG. 2E shows that after selection of the “Limit” category on the title bar 225, the primary and secondary information are reordered by reverse numerical order, with the highest number value first.

FIG. 2E illustrates in display 200 that additional information 235. Additional information can be itemized information related to primary information 205, 210, and/or secondary information 230. For example, primary information displaying a bank can include aggregated information from one or more branches of the bank. Additional information 235 can be the itemized branch information, showing a breakdown of data displayed in the primary and secondary information. Additional information 235 can be displayed by selecting and/or bringing a cursor over primary information 205 individual data.

In an embodiment, the primary information 210 can be displayed as itemized by the additional information 235. For example, when primary information 210 is displayed as a bar chart, the bar of the individual data 205 can be broken down to show one or more components of the chart related to the additional information. If primary information 205, 210 and/or secondary information 230 does not include related additional information 235, the display can show a placeholder, such as a grayed-out area.

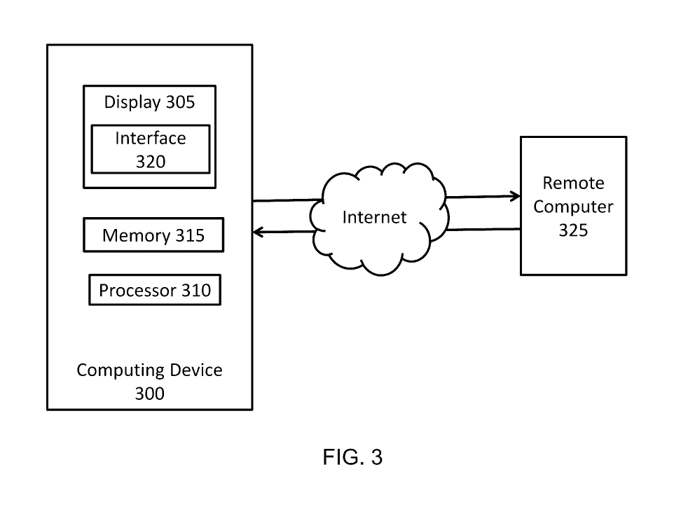

FIG. 3 illustrates a system according to the present disclosure. Computing device 300 can include a display 305, a processor 310, and a memory 315. A graphical user interface 320, as described above in FIGS. 1A to 1C and 2A to 2E can be viewed on the display 305. Computing device 300 can be connected to a remote computer 325, for example, a remote server. The computing device 300 can be electronically connected to the remote computer 325 via an Internet connection, and/or other known wireless connections. The computing device 300 can be connected via wire connection to the remote computer 325. Computing device 300 can be a mobile computing device, such as a mobile phone, table, and/or mobile computer. When a user selection is made in the interface 320, the processor 310 obtains the selected information from the memory 315 and/or the remote computer. The interface 320 can then display the selected information.

A database (not shown) can be included in the computing device 300 and/or the remote computer 325. Primary and secondary information can be stored in the database for retrieval based upon the user selection. For example, primary, secondary, and/or additional information can be stored in the database prior to the computing device 300 showing the information on the display 305. Information can be sent from a database on the remote computer 325 to the computing device 300 where the information is stored until a user retrieves the desired information. Secondary and/or additional information selected can be stored in the database of the computing device 300, but not shown on the display 305 until displayed by expansion of the toggle button and/or expansion button. Information can also be stored in a database on remote computer 325. For example, a user of the interface 320 of computing device 300 selects one or more primary, secondary, and/or additional information for display, and the remote computer sends the selected information to the computing device 300 to be shown on display 305. In an embodiment, an application program (not shown) can be provided in the memory 315 of the computing device 300. The application program can provide a user interface for controlling information on the display.

An example embodiment of the present disclosure is directed to one or more processors, which can be implemented using any conventional processing circuit and device or combination thereof, e.g., a CPU of a Personal Computer (PC) or a mobile computer or other workstation processor, to execute code provided, e.g., on a hardware computer-readable medium including any conventional memory device, to perform any of the methods described herein, alone or in combination. The one or more processors can be embodied in a server or user terminal or combination thereof. The user terminal can be embodied, for example, as a desktop, laptop, hand-held device, Personal Digital Assistant (PDA), television set-top Internet appliance, mobile telephone, smart phone, etc., or as a combination of one or more thereof. The memory device can include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present disclosure is directed to a non-transitory, hardware computer-readable medium, e.g., as described above, on which are stored instructions executable by a processor to perform any one or more of the methods described herein.

An example embodiment of the present disclosure is directed to a method, e.g., of a hardware component or machine, of transmitting instructions executable by a processor to perform any one or more of the methods described herein.

The above description is intended to be illustrative, and not restrictive. Those skilled in the art can appreciate from the foregoing description that the present disclosure may be implemented in a variety of forms, and that the various embodiments can be implemented alone or in combination. Therefore, while the embodiments of the present disclosure have been described in connection with particular examples thereof, the true scope of the embodiments and/or methods of the present disclosure should not be so limited since other modifications will become apparent to the skilled practitioner upon a study of the drawings and specification. Also, where certain claims recite methods, sequence of recitation of a particular method in a claim does not require that that sequence is essential to an operable claim. Rather, particular method elements or steps could be executed in different orders without departing from the scope or spirit of the disclosure.

What is claimed is:

1. A method for an adaptive user interface control on a display of a computing device, comprising:
displaying primary information in a graphical user interface on the display, the primary information being provided by a processor of the computing device, the processor receiving the primary information for display from a remote computer electronically connected to the processor;
providing one or more secondary information for selection viewable with the primary information on the display, the selection of the secondary information based on user input such that the selected secondary information is provided by the remote computer to the computing device; and
adaptively displaying in the graphical user interface a toggle button including the selected secondary information displayable when the toggle button is expanded and hidden when the toggle button is contracted;
wherein the secondary information is data related to the primary information and viewable on the display of the computing device simultaneously in the graphical user interface.

2. The method according to claim 1, further comprising:
linking additional information to the secondary information, wherein the additional information is displayable by selection of at least one of the primary information and the secondary information.

3. The method according to claim 1, wherein the computing device is a mobile computing device.

4. The method according to claim 1, wherein the primary information is displayed in chart form.

5. The method according to claim 1, wherein the secondary information is displayed in table form.

6. The method according to claim 2, wherein the additional information is displayed in list form below the selected secondary information.

7. The method according to claim 5, wherein the secondary information is displayed in table form and aligned with the respective primary information displayed in chart form.

8. A system for an adaptive user interface control on a display of a computing device, comprising:
at least one remote computer;
a computing device including a processor, memory, and display;
a user interface on the display of the computing device for controlling information on the display;
wherein, the system is configured to:
display primary information in a graphical user interface on the display, the primary information being provided by a processor of the computing device, the processor receiving the primary information for display from a remote computer electronically connected to the processor;
provide one or more secondary information for selection viewable with the primary information on the display, the selection of the secondary information based on user input such that the selected secondary information is provided by the remote computer to the computing device; and
adaptively display in the graphical user interface a displayable toggle button including the selected secondary information displayed when the toggle button is expanded and hidden when the toggle button is contracted;
wherein the secondary information is data related to the primary information and viewable on the display of the computing device simultaneously in the graphical user interface.

9. The system according to claim 8, wherein the system is further configured to:
linking additional information to the secondary information, wherein the additional information is displayable when the displayed secondary information in the toggle button is selected.

10. The system according to claim 8, wherein the computing device is a mobile computing device.

11. The system according to claim 8, wherein the primary information is displayed in chart form.

12. The system according to claim 8, wherein the secondary information is displayed in table form.

13. The system according to claim 9, wherein the additional information is displayed in list form below the selected secondary information.

14. The system according to claim 11, wherein the secondary information is displayed in table form and aligned with the respective primary information displayed in chart form.

15. A method for an adaptive user interface control on a display of a computing device, comprising:
displaying primary information in a graphical user interface on the display;
providing one or more secondary information for selection viewable with the primary information on the display, the selection of the secondary information based on user input; and
adaptively displaying in the graphical user interface a displayable toggle button including the selected secondary information displayed when the toggle button is expanded and hidden when the toggle button is contracted;
wherein the secondary information is data related to the primary information and viewable on the display of the computing device simultaneously in the graphical user interface.
